(19) United States
(12) Patent Application Publication
(10) Pub. No.: US 2007/0232785 A1
(43) Pub. Date: Oct. 4, 2007

(54) Process for neutralization of the residual acidity contained in the phenolic compounds

(76) Inventor: Franck Weber, Rouhling (FR)

Correspondence Address: YOUNG & THOMPSON, 745 SOUTH 23RD STREET, 2ND FLOOR, ARLINGTON, VA, 22202, US

(21) Appl. No.: 11/723,072

(22) Filed: Mar. 16, 2007

(30) Foreign Application Priority Data
Mar. 20, 2006 (EP) 06300248.9

(51) Int. Cl. C08F 6/02

(52) U.S. Cl. 528/488; 528/489; 528/492

(57) ABSTRACT

This invention relates to a process for neutralization of the residual acidity that is contained in the phenolic compounds. Process, characterized in that it consists in adding a neutralizing compound that comprises a reactive product to the organic and inorganic acids and a coating compound such that the reactive product reacts only after the beginning of the polymerization, whereby the coating compound allows a controlled release with a conditional or gradual delay of the reactive compound so as to not prevent and to minimize its interferences in the cross-linking of the polymer. The invention is more particularly applicable in the domain of industry, in particular industries of mining and construction using compounds based on formophenolic resin.

This invention relates to all the domains of the industry, in particular industries of mining and construction using compounds based on formophenolic resin, in particular having a catalysis that entrains the presence of mineral acid or residual organic acid and has as its object a process for neutralization of this residual acidity.

The invention also has as its object the means that are implemented by this process.

The object of this invention is to obtain a reduction of the residual acidity that is present in the compounds that are based on formophenolic resin, in particular having a catalysis that entrains the presence of mineral acid or residual organic acid, so as to avoid health problems, environmental problems, corrosion or degradation of the substrates or other materials that have this type of reaction with acids.

In a majority of applications, the polymerization of the resol-type phenolic resins requires the presence of acid. The necessary amount of acid will depend on the type of resol, the type of application and temperature conditions. The most simple method for neutralizing acid is the use of a strong base. The addition of alkaline, however, causes quick neutralization of the acid and will therefore prevent it from playing its role as catalyst. In addition, the addition of alkaline in the resol-type phenolic resins causes a faster increase of their viscosity over time and can go so far as a complete condensation based on the added amount. It is possible to add less reactive products to the acid that will play the role of buffer. To be effective, these products should be used in a large amount, and the result that is obtained is still not optimum. It is possible to cite, for example, aluminum hydrates.

Neutralization is now carried out by additions or passage of alkaline into the already formed polymer, when this is possible, for example essentially on foams, or else by adding alkaline to the surface of the finished polymer. For this purpose, a process that is known by U.S. Pat. No. 5,232,745 consists in neutralizing the surfaces. According to this document, a phenolic foam panel is used, whose faces are covered by glass fiber that contains a neutralizing agent (inorganic metallic salt) that is applied in powder form or in aqueous solution. However, the process that is described allows only a surface neutralization, and a residual acidity persists that rises to the surface of the foam, whereby no coated alkaline agent is provided in the entire polymer to obtain a delayed action.

Another known neutralization process is the passage of alkalines in gaseous form, for example, ammonia, in the foam (U.S. Pat. No. 3,522,196). This process, like the preceding process, can be applied only to preformed or pre-cut pieces and is difficult to transfer to products that can be sprayed, injected or directly installed on site. Furthermore, a gas phase neutralization is also described in JP-A-09048833, but this process no longer uses a coated alkaline delayed-action agent.

WO-A-98/42775 describes the use of glycols and alcohols that are reactive, such as furfuryl alcohol and resorcinol, whose action begins upon contact with the acid, i.e., in a non-delayed manner after cross-linking. Likewise, in the process according to JP-A-05261703, no alkaline agent with delayed action after cross-linking is described, whereby a staggered action, with regard to the time of reaction with the acid, is obtained only by use of large particles of zinc and iron powder, whose action begins upon contact with the acid.

U.S. Pat. No. 4,307,206 describes only urea-formaldehyde resins that have ammonium chloride as a cross-linking agent, which is an acid that is low in solution in water, namely a pH=5.6, and does not consider any possible use in resol-type phenolic resins.

In the process according to this document, hydrochloric acid is not present at the beginning of the reaction and gradually forms during the cross-linking of the urea-formaldehyde resin, whereby the ammonium chloride reacts with the formaldehyde to form the hydrochloric acid. In this case, the acid is therefore a reaction product that has undesirable effects on the finished product.

There are also other processes whose objects are so-called non-corrosive systems, as described in U.S. Pat. No. 4,122,045, which have as their object the action of sodium tetraborate in connection with boric acid. This process does not use a coated alkaline agent to delay its action after cross-linking, but rather large particles of sodium tetraborate, whose action begins upon contact with the acid and in which it is essentially the size of the particle that makes it possible to stagger the reactions with acid over time.

In these various processes, the acid that is present is not totally neutralized.

This invention has as its object to remedy these drawbacks by proposing a process for neutralization of the residual acidity that results from the presence of mineral acid or residual organic acid that is due to the catalysis of the compounds based on formophenolic resin.

For this purpose, the process for neutralization of the residual acidity that is contained in the phenolic compounds that consist of resol-type phenolic resins—implemented by catalysis with one or more organic or inorganic acids, such as sulfuric acid, phosphoric acid, a strong organic acid such as the arylsulfonic acids such as the phenolsulfonic acids, toluenesulfonic acids, methanesulfonic acids, a modified organic or arylsulfonic acid, a carboxylic acid, such as lactic acid, maleic acid, used in mixtures with one or more strong acids, whereby these acids are both catalysts and optionally make possible a chemical blow molding of the phenolic compound by reaction with carbonate compounds, such as sodium bicarbonate, calcium carbonate, by themselves or in a mixture—is characterized in that it consists in adding a neutralizing compound that comprises a reactive product with the organic and inorganic acids and a coating compound, such that the reactive product reacts only after the beginning of the polymerization, whereby the coating compound makes possible a controlled release with a conditional or gradual delay of the reactive compound so as to not prevent and to minimize its interferences in the cross-linking of the polymer.

Mention will be made below of the so-called “neutralizing” compound. This “neutralizing” compound will comprise a so-called “reactive” compound with regard to the acid or acids and a so-called “coating” compound that delays this reaction.

The invention uses compounds that are coated, packed or that have undergone a surface treatment that can slow their neutralization reaction of the acid. Such a treatment makes it possible for the acid to play its role as catalyst on the resin in a first step and secondarily its role in the expansion phenomenon that is obtained by decomposition of carbonate compounds by themselves or in a mixture, such as, for example, calcium carbonate, sodium bicarbonate, etc., with or without the presence of one or more surfactants that make it possible to stabilize the thus formed foam. Such a treatment is described in particular in EP 0 629 655 B1.

The residual acid is neutralized, in a second step, when the coating, the packing or the surface treatment is removed. For this purpose, the neutralizing compound can preferably, but not necessarily, be added stoichiometrically relative to the amount of acid groups to be neutralized.

The treatment, the packing or the coating of the neutralizing compound should make possible the neutralization of the residual acidity that is contained in the material after its polymerization or at the end of polymerization.

Neutralization is defined as the pH of the phenolic compound, after its use, preferably being located between 6 and 8 regardless of the moisture conditions.

The invention is more particularly suitable in the processes that use resol-type phenolic resins. This resol is then used with an acid-type catalysis.

The reactive compound should react with the acid groups that are encountered so as to neutralize them. These acids can be either mineral acids, such as, for example, sulfuric acid, phosphoric acid, . . . or arylsulfonic acids that may or may not be modified, such as, for example, phenolsulfonic acid, toluenesulfonic acid, benzenesulfonic acid, methanesulfonic acid, . . . or carboxylic acids, such as oxalic acid, lactic acid, benzoic acid, . . . , by themselves or in a mixture. In the case of carboxylic acids, it is often necessary to combine them with one or more strong acids.

The reactive compound preferably comes in liquid, solid or wax form at ambient temperature. Ambient temperature is defined as the temperature range that the product can undergo before its use (production, storage, preheating, . . . ).

The reactive compound can also be a natural compound such as rock powders, or in synthetic form.

Furthermore, the reactive compound can also be a rock powder that may or may not be soluble in water, namely, such as:

1. The carbonates, preferably sodium, calcium, potassium, zinc, basic zinc, magnesium, iron, ammonium, manganese, copper, and basic copper carbonates. . .

2. The bicarbonates, preferably ammonium, potassium and sodium bicarbonates. . .

3. The hydroxides, preferably calcium, magnesium, potassium, and sodium hydroxides. . .

4. The oxides, preferably magnesium, calcium and zinc oxides. . .

5. The silicates, preferably sodium and potassium silicates. . .

6. The phosphates, preferably tri-potassic, calcium, copper, potassium, magnesium, sodium, and zinc phosphates, sodium hexa meta phosphate, and tetrapotassic pyrophosphate, . . .

Finally, the reactive compound can be a preferably solid, organo mineral compound such as, for example, the soda-containing glycine carbonate effervescent compounds, or else an organic compound, such as the phenolates, or the primary amines.

The alkaline compounds that have a pH of more than 9 in 1% solution are to be preferred in a general way and in particular if the amount of solid that can be incorporated in the product is limited and/or if the amount of acid to be neutralized is high. For this purpose, by way of example, the calcium carbonates (pH 9.5), magnesium hydroxides (pH 10.6), magnesium oxides (10.8), barium hydroxides (13.4), etc., advantageously will be used. Certain compounds that are not very soluble in aqueous media, such as sodium bicarbonate (pH 8.0), have a low pH in solution but easily react with the acids.

The compounds that can release a gas during their reaction with acid, such as carbonates and bicarbonates, can generate problems of structures or modifications of properties in the final polymer, for example by increasing the percentage of open cells in a phenolic foam. In the same manner, the least dangerous and the most available products will be promoted.

The various compounds listed above are not, of course, cited in an exhaustive manner.

The term coating compound refers to the compound or compounds that are used to encase the reactive compound or compounds so as to differentiate the actions thereof. Other terms can be used, namely the film-forming agents, the enveloping agents, the controlled-release excipients, the matrices for delayed-release, etc.

A film-forming or enveloping agent is used to form a thin film around the reactive compound.

A controlled-release excipient or a matrix for delayed-release is an ingredient that is contained in a system that makes it possible for a compound to be released over time.

A sequestering agent is an agent whose molecular structure can envelope and preserve a certain type of ion and that modifies its interaction with the other ingredients such as potassium citrate or tartaric acid.

The coating compound can be of a different nature, namely, for example:
A polymer of natural origin, such as gelatin, casein, chitosan, agarose, amidon and modified amidon, sodium alginate, . . .
A cellulose-derivative semi-synthetic polymer such as cellulose acetates, cellulose phthalate acetate, butyrate cellulose, ethyl cellulose, methyl cellulose, hydroxypropylmethyl cellulose, cellulose acetate-trimetallitate, etc . . .
A synthetic polymer, such as, for example, acrylic and methacrylic ester copolymers, polyolefins, polyethylenes, polypropylenes, acrylo-vinyl copolymers, etc.
A solid lipid at ambient temperature of the type of fatty acids such as palmitic acid, stearic acid; fatty alcohols, long-chain glycerides, cholesterol derivatives, waxes of various origins, such as carnauba wax, beeswax, etc.
A wax of petroleum origin (so-called mineral wax), such as, for example, paraffins, branched paraffin compounds, naphthenic hydrocarbons, etc.
Soluble products such as sugars or sugar derivatives.

Fatty matrices of the hydrogenated vegetable oil type make it possible, owing to their differing melting points, to adjust the rate of release. It is the same for the cellulose matrices by varying the lactose/ester proportions of cellulose cellulose-acetate, cellulose acetobutyrate and cellulose acetopropionate and by adding a plasticizer.

Furthermore, the cellulose esters, cellulose acetate (CA), cellulose acetobutyrate (CAB) and cellulose acetoproponate (CAPr) form insoluble films that are used in delayed-release or extended-release forms.

The coating compound can be deactivated in various ways, for example under the action of heat, a solvent, a modification of the surface tensions, a chemical reaction making possible its degradation or a modification of its physical or chemical form entraining the release of the reactive compound.

This coating can be such that it can be degraded, liquefied or dissolved under the action of heat and can come in the form of paraffins or thermosetting compounds, such as polyethylene. Thus, from a defined temperature, the compound will be released and can neutralize the residual acidity. This temperature can be generated by the exothermal reaction or by an outside heat source, for example by putting the compound in an oven after polymerization.

The activation temperature can vary based on the type of coating materials selected, thus, for example, for a paraffin 42-44, the melting point will be between 42° C. and 44° C., whereas for a paraffin 59-61, this melting point will be between 59° C. and 61° C. For beeswax, the melting point will be between 62° C. and 65° C., whereas for a candelilla wax, said melting point will be between 67° C. and 69° C., and for a carnauba wax, it will be between 83° C. and 86° C. In the case of use of methyl palmitate, the melting point will be between 29.5° C. and 30° C., whereas for the sorbitol palmitate, this melting point will be between 47° C. and 78° C. For zinc palmitate, this melting point will be 100° C. and for copper palmitate, this temperature will be 120° C.

The melting point of a thus used dipropylene glycol stearate is between 34° C. and 35° C. and that of a monopropylene glycol stearate is between 37° C. and 39° C. A methyl stearate will exhibit a melting point 39° C., while a polyvinyl stearate will have a melting point of between 47° C. and 48° C. In the case of use of a diethylene glycol stearate, the melting point will be between 54° C. and 59° C. and in that of an ethylene glycol stearate, it will be 60° C. to 61° C. The melting point of a glycerol stearate will be 81° C. and that of a quanidine stearate is between 84° C. and 86° C. Finally, the melting point of a magnesium stearate is 88.5° C. and that of a manganese stearate is 100° C.

Several coating compounds can be combined for staging the release of the neutralizing compound.

The coating or surface treatment can impart a hydrophobic or hydrophilic effect to the compound, according to the desired result, the compound to be coated and the product in which it is to be introduced. Furthermore, it may be of organic nature, namely with a sugar or mineral base, for example with a base of more or less soluble salts or with an organo-mineral base, such as a calcium stearate base.

The thickness of the coating or the surface treatment can be modified so as to optimize the reaction time relative to the nature or the amount of residual acid and the time of use of the product.

The selection of coating material is made based on the product to be coated, the product in which the neutralizing compound is to be introduced and the type of application. For example, in the case of phenolic foams, a coating product that impairs the quality of the foam only slightly or not at all will be selected so as to avoid phenomena such as collapsing, lamination, retraction . . . . Some of these problems can also be resolved or minimized using suitable surfactants.

The coating material can be modified to facilitate the incorporation of the neutralizing compound in the phenolic matrix, for example by ethoxylation, to improve the incorporation in an aqueous phase resol.

The coating compound can also be of a porous nature, so as to limit or condition the access of the acid to the reactive compound, allowing a gradual neutralization of the latter.

It is possible to add plasticizing agents that are used as a film-coating component or as an addition to another coating means. These compounds, such as lanolin alcohol, promote the distribution of the coating over the solids, beads, granules, etc.

The neutralizing compounds can be used by themselves or in combination with other neutralizing compounds. Thus, by way of example, a combination of neutralizing compounds that have different delaying effects makes it possible to stagger the neutralization reactions over time.

The neutralizing compound can be used in combination with other untreated substances that can act as buffers, such as, for example, sodium citrates, tripotassium citrate, trisodium citrate, tetrahydrated tricalcium dicitrate, and aluminum trihydrates. These substances will preferably be not very soluble or non-soluble in aqueous medium, and their pH in solution will be less than 9 to avoid too fast an action with the acid or acids that are present so as not to influence negatively the polymerization and, if necessary, the expansion of the product.

By way of examples, the substances that can play the role of buffer will be as follows:
Trisodium citrate (trisodic salt citric acid): pH 7.5 to 9 for 10 g/l.
Tripotassium citrate (tripotassic salt citric acid): pH 5 to 6 for 25 g/l.
Tricalcium dicitrate: pH 7.5 to 9 for 10 g/l.
Citrate/sodium hydroxide mixture: pH 6.
Monohydrated dipotassium oxalate: pH 7.0 to 8.5 for 50 g/l.
Disodium oxalate: pH 8 for 30 g/l.
Aluminum hydroxide (hydrargillite, hydrated aluminum oxide): pH 8 to 9 for 100 g/l.

The hydroxides of certain compounds are also known under the term hydrate or trihydrate. It is possible to cite, for example, aluminum trihydrate, barium hydrate, etc.

The amount of neutralizing compound will preferably, but not necessarily, be added stoichiometrically relative to the amount of acid group to be neutralized, so as not to reduce the performance levels or to degrade the formed polymer.

The physical parameters of the neutralizing compound and the reactive compound, such as, for example, the grain size, the specific surface area, the shape, and the color can be adapted to the conditions for application and to the desired properties of the finished product. For example, it is possible to select particles of small grain size with large specific surface area to reduce the risks of sedimentation of the neutralizing compound in the resol.

The incorporation, the dispersion and the wetting of the neutralizing compound or compounds can be facilitated by the addition of a surfactant.

In addition, the neutralizing compound can be incorporated in one or the other of the parts (resol, acid catalyst, etc.) if the nature of the coating, as well as its chemical and physical compatibility, allow it.

The neutralizing compound preferably comes in solid form or in the form of waxes that can be dispersed at ambient temperature. Ambient temperature is defined as the temperature range that the product can undergo before its use (production, storage, preheating, . . . ), without being activated, so as not to release the reactive compound before polymerization.

Other forms of neutralizing compound can be used, such as, for example, carbon-containing structures that contain the reactive compound, forms such as micelles, liposomes, spherulites that isolate the reactive compound, nanomaterials that include a reactive compound, encapsulated or micro-encapsulated reactive liquids, without thereby exceeding the scope of the invention.

According to a characteristic of the invention, the neutralizing compound can be incorporated in the resin or added during the mixing of the resin and the acid catalyst. It is also possible to produce the mixture using a dynamic or static mixer.

According to another characteristic of the invention, the powder compounds can be used as is, in the form of paste or in suspension in a liquid that makes possible their incorporation into the final mixture.

The product that is used by the process according to the invention can come in the form of bi-, tri- or multi-components according to the desired use.

The ratio between the different products and their temperature of use is variable and should be adjusted based on the application (reaction times, ambient temperatures, etc.).

According to another variant embodiment of the invention, the activation of the neutralizing compound is carried out after the formation of polymer. For example, by using a coating compound whose melting point or whose heat degradation is greater than the polymerization temperature, it is possible to release the reactive compound at any time by a heat cycle whose temperature is greater than the melting point of the coating compound.

Further, it is also possible to use in addition either physical blow molding agents, such as compounds from the group of hydrogenated chloro-fluorohydrocarbons, incompletely halogenated hydrocarbons or else hydrocarbons such as n-pentane, cyclopentane and hexane, or feedstocks that may or may not be structural, such as balls or microballs of glass, talc, or kaolin, or reinforcements such as mineral fibers or microfibers (glasses, rocks) or organic fibers (aramides, cellulose, . . . ), or else dyes, flame retardants in liquid or solid form, plasticizers, solvents, feedstocks that are specific to certain fields (for example neutrophages), reactive products such as resorcinol, furfuryl alcohol, . . . , agents for trapping volatile organic components.

Thanks to the invention, it is possible to use strong acids that are present from the beginning of the reaction, such as, for example, sulfuric acid, phenolsulfonic acid, etc., as catalysts on the resol-type phenolic resins, whereby this strong acid is simultaneously used as a reactive agent that allows chemical blow molding by decomposition of a carbonate compound, such as calcium carbonate or sodium bicarbonate, and is neutralized only when these reactions have taken place. In contrast, in the process that is known according to U.S. Pat. No. 4,307,206, the hydrochloric acid is not present at the beginning of the reaction and is formed gradually, during the cross-linking, by the urea-formaldehyde resin and is therefore a reaction product that has undesirable effects on the finished product.

Of course, these products should be selected for their compatibility with the process and can just as well be added by themselves or mixed with one or another of the parts.

1. Process for neutralization of the residual acidity that is contained in the phenolic compounds that consist of resol-type phenolic resins—implemented by catalysis with one or more organic or inorganic acids, such as sulfuric acid, phosphoric acid, a strong organic acid such as the arylsulfonic acids such as the phenolsulfonic acids, toluenesulfonic acids, methanesulfonic acids, a modified organic or arylsulfonic acid, a carboxylic acid, such as lactic acid, or maleic acid, used in mixtures with one or more strong acids, whereby these acids are both catalysts and optionally make possible a chemical blow molding of the phenolic compound by reaction with carbonate compounds, such as sodium bicarbonate, calcium carbonate, by themselves or in a mixture—characterized in that it consists in adding a neutralizing compound that comprises a reactive product to the organic and inorganic acids and a coating compound, such that the reactive product reacts only after the beginning of the polymerization, whereby the coating compound makes possible a controlled release with a conditional or gradual delay of the reactive compound so as to not prevent and to minimize its interferences in the cross-linking of the polymer.

2. Process, according to claim 1, wherein it uses compounds that are coated, packed or that have undergone a surface treatment that can slow their neutralization reaction of the acid.

3. Process, according to claim 1, wherein it consists in neutralizing the residual acid that is contained in the material after its polymerization or at the end of polymerization in a second step, when the coating, the packing or the surface treatment is removed.

4. Process according to claim 1, wherein the neutralizing compound is added stoichiometrically relative to the amount of acid groups to be neutralized.

5. Neutralizing compound used by the process according to claim 1, wherein it comprises a so-called “reactive” compound with regard to the acid or acids and a so-called “coating” compound that delays this reaction.

6. Reactive compound that is used by the process according to claim 1, wherein it comes in liquid, solid or wax form at ambient temperature.

7. Reactive compound, according to claim 6, wherein it is a natural compound, such as rock powders, or is in synthetic form.

8. Reactive compound, according to claim 6, wherein it is a mineral powder that may or may not be soluble in water, namely such as:
1. The carbonates, preferably sodium, calcium, potassium, zinc, basic zinc, magnesium, iron, ammonium, manganese, copper, and basic copper carbonates . . . ,
2. The bicarbonates, preferably ammonium, potassium and sodium bicarbonates . . .
3. The hydroxides, preferably calcium, magnesium, potassium, and sodium hydroxides. . .
4. The oxides, preferably magnesium, calcium and zinc oxides . . .
5. The silicates, preferably sodium and potassium silicates . . .
6. The phosphates, preferably tri-potassic, calcium, copper, potassium, magnesium, sodium, and zinc phosphates, sodium hexa meta phosphate, and tetrapotassic pyrophosphate, . . . .

9. Reactive compound, according to claim 6,
wherein it is a preferably solid organo mineral compound, such as, for example, the soda-containing glycine carbonate effervescent compounds or else an organic compound, such as the phenolates, or the primary amines.

10. Coating compound that is used by the process according to claim 1, wherein it is:
A polymer of natural origin, such as gelatin, casein, chitosan, agarose, amidon and modified amidon, sodium alginate, . . .
A cellulose-derivative semi-synthetic polymer such as cellulose acetates, cellulose phthalate acetate, butyrate cellulose, ethyl cellulose, methyl cellulose, hydroxypropylmethyl cellulose, cellulose acetate-trimetallitate, etc.
A synthetic polymer, such as, for example, acrylic and methacrylic ester copolymers, polyolefins, polyethylenes, polypropylenes, acrylo-vinyl copolymers, etc.
A solid lipid at ambient temperature of the type of fatty acids such as palmitic acid, stearic acid; fatty alcohols, long-chain glycerides, cholesterol derivatives, waxes of various origins, such as carnauba wax, beeswax, etc.
A wax of petroleum origin (so-called mineral wax), such as, for example, paraffins, branched paraffin compounds, naphthenic hydrocarbons, etc.
Soluble products such as sugars or sugar derivatives, and wherein it is deactivated in various ways, for example under the action of heat, a solvent, a modification of surface tensions, a chemical reaction making possible its degradation or a modification of its physical or chemical form entraining the release of the reactive compound.

11. Coating compound, according to claim 10,
wherein it is used by itself or in combination.

12. Coating compound, according to claim 10, wherein it is of an organic nature, namely with a sugar or mineral base, for example with a base of more or less soluble salts or with an organo-mineral base, such as a calcium stearate base.

13. Coating compound, according to claim 10, wherein its thickness is variable so as to optimize the reaction time relative to the nature or the amount of acid released by the reaction and the time of use of the product.

14. Coating compound, according to claim 10, wherein it is modified to facilitate the incorporation of the neutralizing compound in the phenolic matrix, for example by ethoxylation, to improve the incorporation in a resol in aqueous phase.

15. Coating compound, according to claim 10, wherein it is of a porous nature so as to limit or to condition the access of the acid to the reactive compound that makes possible a gradual neutralization of the latter.

16. Coating compound, according to claim 10, wherein it also comprises surfactants or plasticizing agents.

17. Neutralizing compound that is used by the process according to claim 1, wherein it is used by itself or in combination with other neutralizing compounds and is added in a manner that may or may not be stoichiometric relative to the amount of the acid group that is to be neutralized, so as not to reduce the performance levels or to degrade the polymer formed.

18. Neutralizing compound, according to claim 17, wherein it is used in combination with other non-treated substances that can act as buffers, such as, for example, sodium citrates, tripotassium citrate, trisodium citrate, tetrahydrated tricalcium dicitrate, and aluminum trihydrates, whereby these substances are not very soluble or are non-soluble in aqueous media, and their pH in solution is less than 9.

19. Neutralizing compound, according to claim 17, wherein it comes in solid form or in the form of waxes that can be easily dispersed at ambient temperature.

20. Neutralizing compound, according to claim 17, wherein it is in the form of carbon-containing structures that contain the reactive compound such as micelles, liposomes, spherulites that isolate the reactive compound, nanomaterials that include a reactive compound, encapsulated or micro-encapsulated reactive liquids.

21. Neutralizing compound, according to claim 17, wherein it is also supplemented by physical blow molding agents, such as compounds from the group of hydrogenated chloro-fluorohydrocarbons, incompletely halogenated hydrocarbons or else hydrocarbons such as n-pentane, cyclopentane and hexane, or feedstocks that may or may not be structural, such as balls or microballs of glass, talc, or kaolin, or reinforcements such as mineral fibers or microfibers (glasses, rocks) or organic fibers (aramides, cellulose, . . . ), or else dyes, flame retardants in liquid or solid form, plasticizers, solvents, feedstocks that are specific to certain fields (for example neutrophages), reactive products such as resorcinol, furfuryl alcohol, . . . , agents for trapping volatile organic components.

22. (canceled)
